(19) United States
(12) Patent Application Publication
(10) Pub. No.: US 2013/0021167 A1
(43) Pub. Date: Jan. 24, 2013

(54) WIRELESS MONITORING AND CONTROL OF SAFETY STATIONS IN A PROCESS PLANT

(71) Applicant: Ronald D. Harper, JR., Georgetown, IN (US)

(72) Inventor: Ronald D. Harper, JR., Georgetown, IN (US)

(73) Assignee: General Equipment and Manufacturing Company, Inc., d/b/a TopWorx, Inc., Louisville, KY (US)

(21) Appl. No.: 13/553,647

(22) Filed: Jul. 19, 2012

Related U.S. Application Data
(60) Provisional application No. 61/509,846, filed on Jul. 20, 2011.

(51) Int. Cl. G08C 19/16

(52) U.S. Cl. 340/870.01

(57) ABSTRACT

A safety station for use in a process plant includes one or more leverless limit switches to detect activation of one or more parts of the safety station. The safety station further includes a wireless transmitter coupled to the leverless limit switches to transmit signals associated with the safety station to a base station device, which is communicatively coupled to one or more control and/or monitoring devices.

### FIELD OF THE INVENTION

The present invention relates generally to process plant safety systems and, more particularly, to wirelessly monitoring and controlling safety stations in a process plant.

### DESCRIPTION OF THE RELATED ART

Process control systems, like those used in chemical, petroleum or other processes, typically include one or more centralized or decentralized process controllers communicatively coupled to at least one host or operator workstation and to one or more process control and instrumentation devices such as, for example, field devices, via analog, digital or combined analog/digital buses. Field devices, which may be, for example, valves, valve positioners, switches, transmitters, and sensors (e.g., temperature, pressure, and flow rate sensors), are located within the process plant environment, and perform functions within the process such as opening or closing valves, measuring process parameters, increasing or decreasing fluid flow, etc. Smart field devices such as field devices conforming to the well-known FOUNDATION™ Fieldbus (hereinafter “Fieldbus”) protocol or the HART®. protocol may also perform control calculations, alarming functions, and other control functions commonly implemented within the process controller.

The process controllers, which are typically located within the process plant environment, receive signals indicative of process measurements or process variables made by or associated with the field devices and/or other information pertaining to the field devices, and execute controller applications. The controller applications implement, for example, different control modules that make process control decisions, generate control signals based on the received information, and coordinate with the control modules or blocks being performed in the field devices such as HART and Fieldbus field devices. The control modules in the process controllers send the control signals over the communication lines or signal paths to the field devices, to thereby control the operation of the process.

Information from the field devices and the process controllers is typically made available to one or more other hardware devices such as, for example, operator workstations, maintenance workstations, personal computers, handheld devices, data historians, report generators, centralized databases, etc. to enable an operator or a maintenance person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, diagnosing problems or hardware failures within the process plant, etc.

While a typical process plant has many process control and instrumentation devices such as valves, transmitters, sensors, etc. connected to one or more process controllers, there are many other supporting devices that are also necessary for or related to process operation. These additional devices include, for example, power supply equipment, power generation and distribution equipment, rotating equipment such as turbines, motors, etc., which are located at numerous places in a typical plant. While this additional equipment does not necessarily create or use process variables and, in many instances, is not controlled or even coupled to a process controller for the purpose of affecting the process operation, this equipment is nevertheless important to, and ultimately necessary for proper operation of the process.

Additionally, a process plant typically includes various safety stations (e.g., safety showers, eye wash stations, etc.) located throughout the plant to be used by plant workers in emergency situations. However, unlike the smart field devices described above or other similar field devices, safety stations within a process plant are often in no way monitored or controlled by the process control system or in any other manner. Few control systems that do provide monitoring or control capabilities generally utilize wired communication between the monitoring devices and the safety stations, and such wired communication systems are often expensive and difficult to install. Simpler monitoring systems that utilize wireless links to alarm an operator of a safety station activations generally rely on mechanical switches, flow switches, or proximity detectors to detect safety station activation. However, such detection methods often do not perform well in demanding environments often found in process plants and are often unreliable.

### SUMMARY

In an embodiment, a safety station for use in a process plant includes one or more leverless limit switches to detect activation of one or more parts of the safety station. The safety station further includes a wireless transmitter coupled to the leverless limit switches to transmit signals associated with the safety station to a base station device, which is communicatively coupled to one or more control and/or monitoring devices. In an embodiment, the safety station is a safety shower and/or an eye wash station.

The leverless limit switch, according to an embodiment, is a GO® switch manufactured by the TopWorx corporation. Further, in an embodiment, the leverless limit switch remains latched until physically reset. The wireless transmitter is the Rosemount 702 dual input transmitter manufactured by the Emerson corporation, according to an embodiment. In another embodiment, the wireless transmitter is another intrinsically safe transmitting device. Depending on the embodiment, the control and/or monitoring stations connected to the base station are remote touch screen panels, paperless recorders, workstations, other suitable monitoring and/or control devices, or a combination of such devices.

According to another embodiment, a safety station monitoring and control system in a process plant includes one or more safety stations equipped with a leverless limit switch and a wireless transmitter coupled to the leverless switch, and a base station communicatively coupled a first monitoring and/or control module. In at least some embodiments, the base station is further coupled to a second monitoring and/or control module. In an embodiment, a safety station is a safety shower and/or an eye wash station. Depending on the particular embodiment, the control and/or monitoring stations connected to the base station are remote touch screen panels, paperless recorders, workstations, other suitable monitoring and/or control devices, or a combination of such devices.

In some embodiments, a monitoring and/or control module is configured to detect safety station misuse. Additionally or alternatively, in another embodiment, a monitoring and/or control module is configured to detect a man down situation. Further still, in yet another embodiment, a monitoring and/or control modules is configured to, additionally or alternatively, record safety station activation events for a safety standard compliance.

### DETAILED DESCRIPTION OF THE DRAWINGS

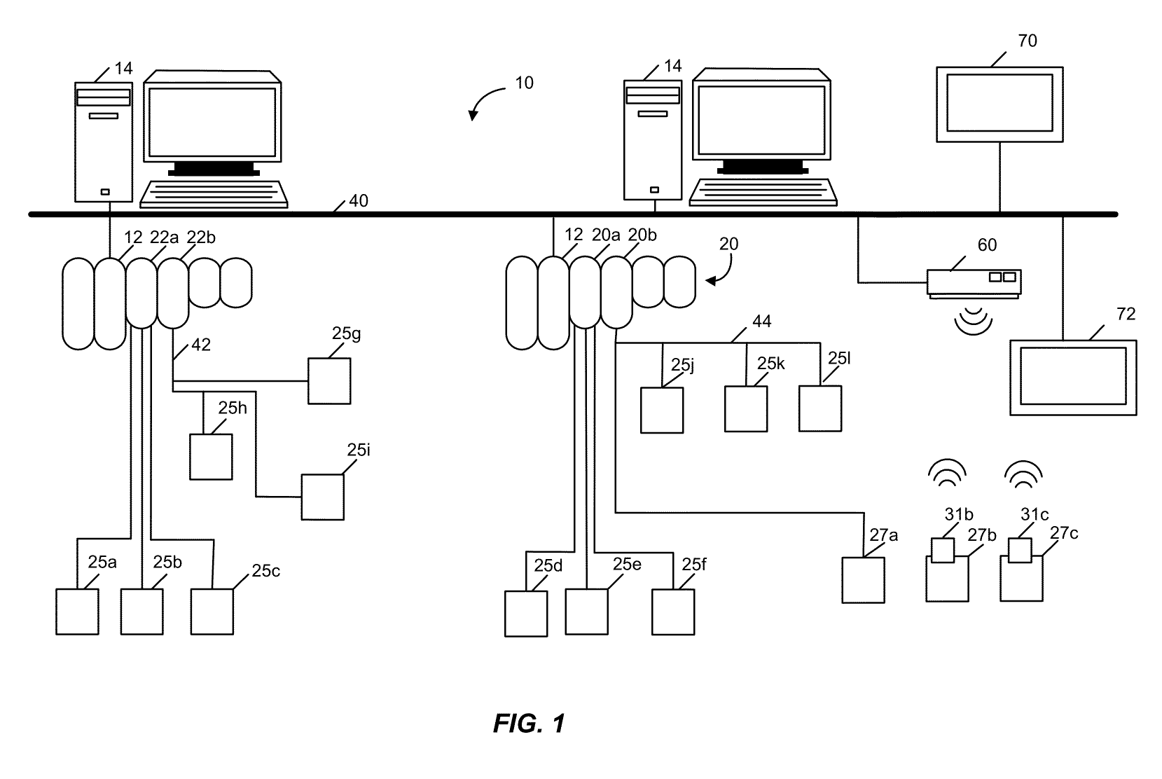

FIG. 1 illustrates an example process control system environment in which a wireless communication link to a safety station may be used, according to an embodiment;

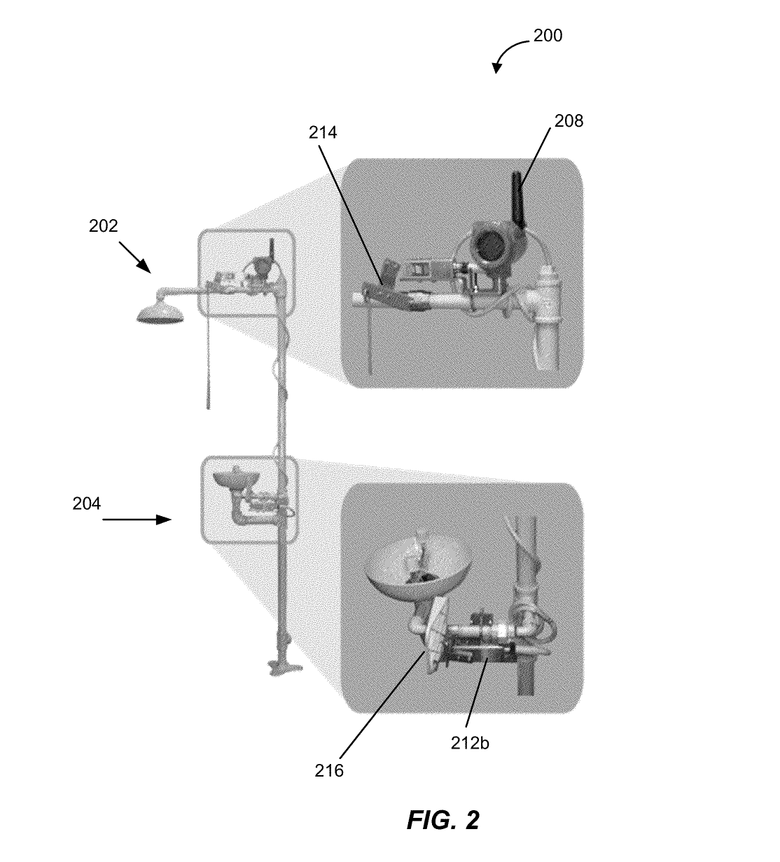

FIG. 2 illustrates an example safety station equipped with a wireless transmitter;

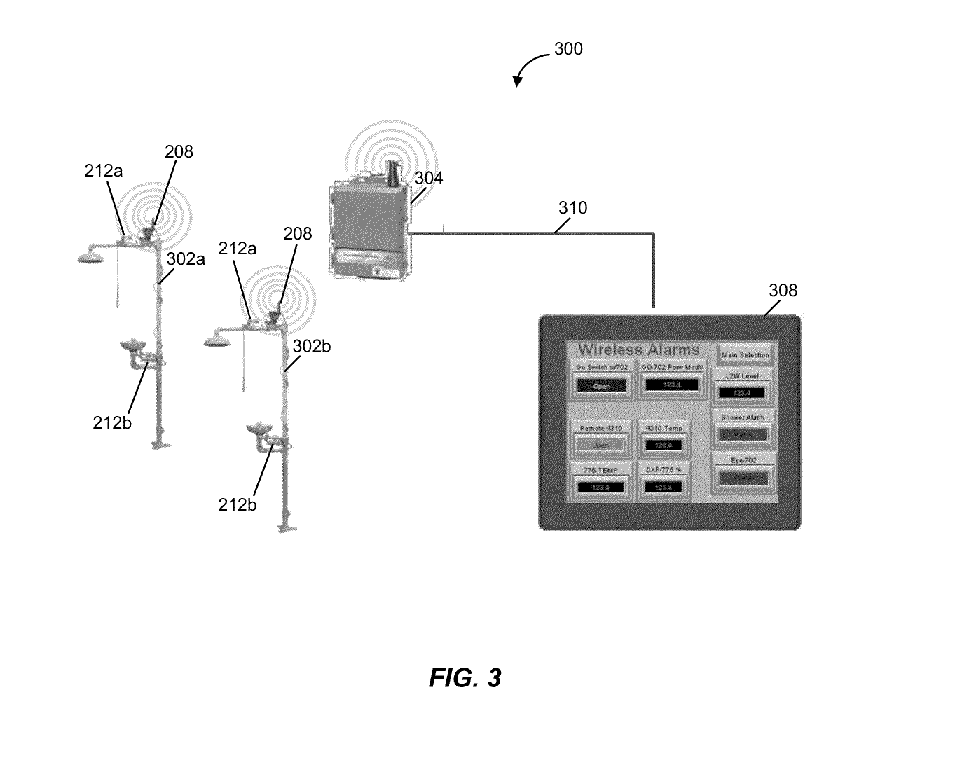

FIG. 3 illustrates an example system configuration utilizing a wireless monitoring link, according to an embodiment;

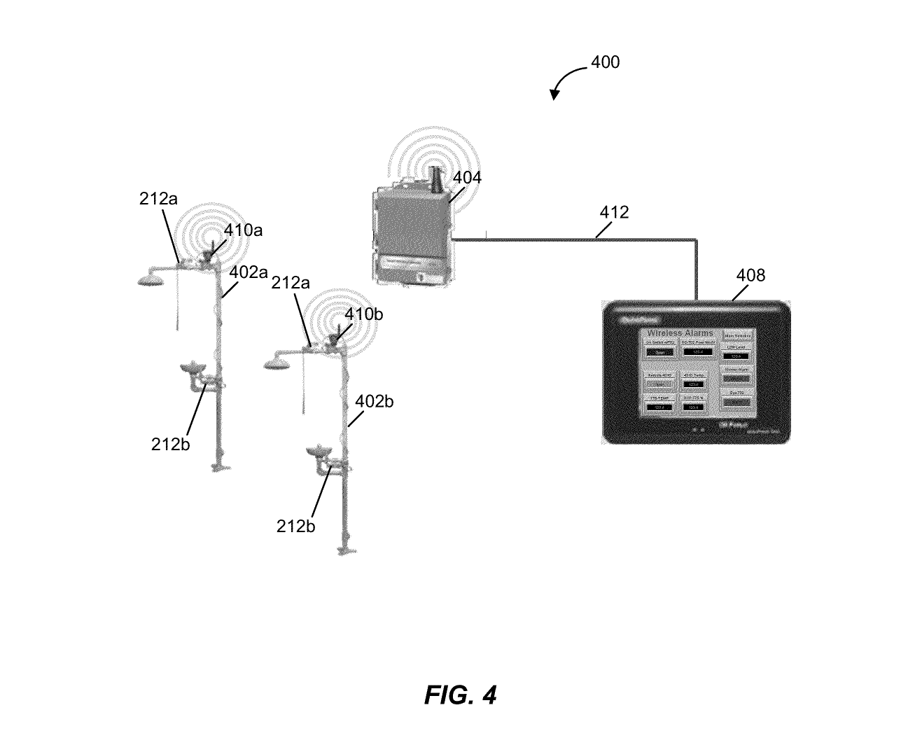

FIG. 4 illustrates another example system configuration utilizing a wireless monitoring link, according to another embodiment;

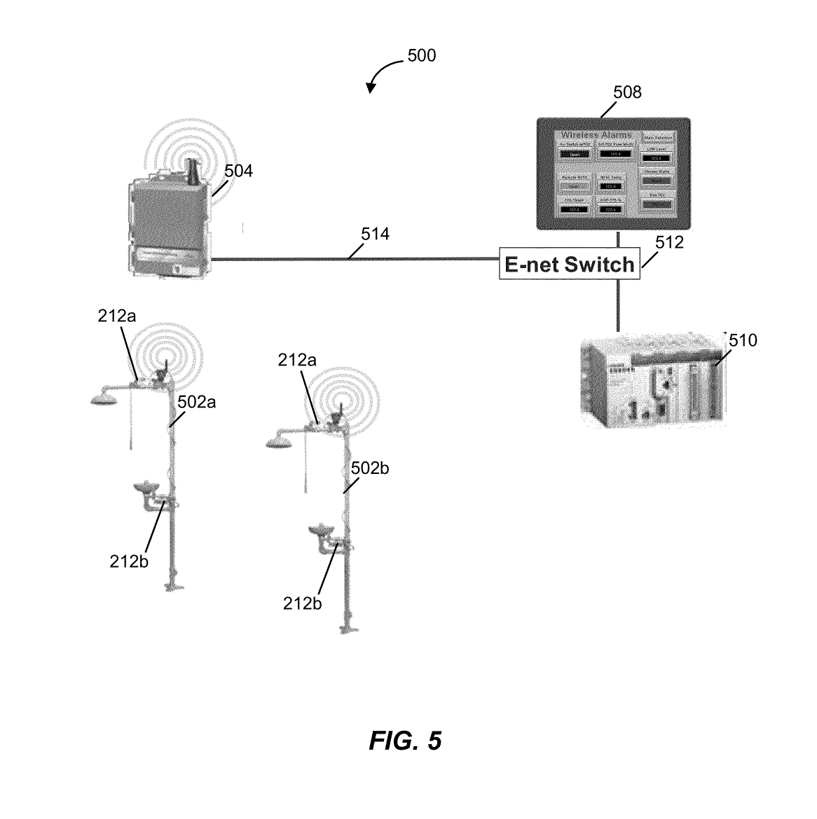

FIG. 5 illustrates an example system configuration within which wireless communication between safety stations and monitoring and control modules may be utilized, according to an embodiment;

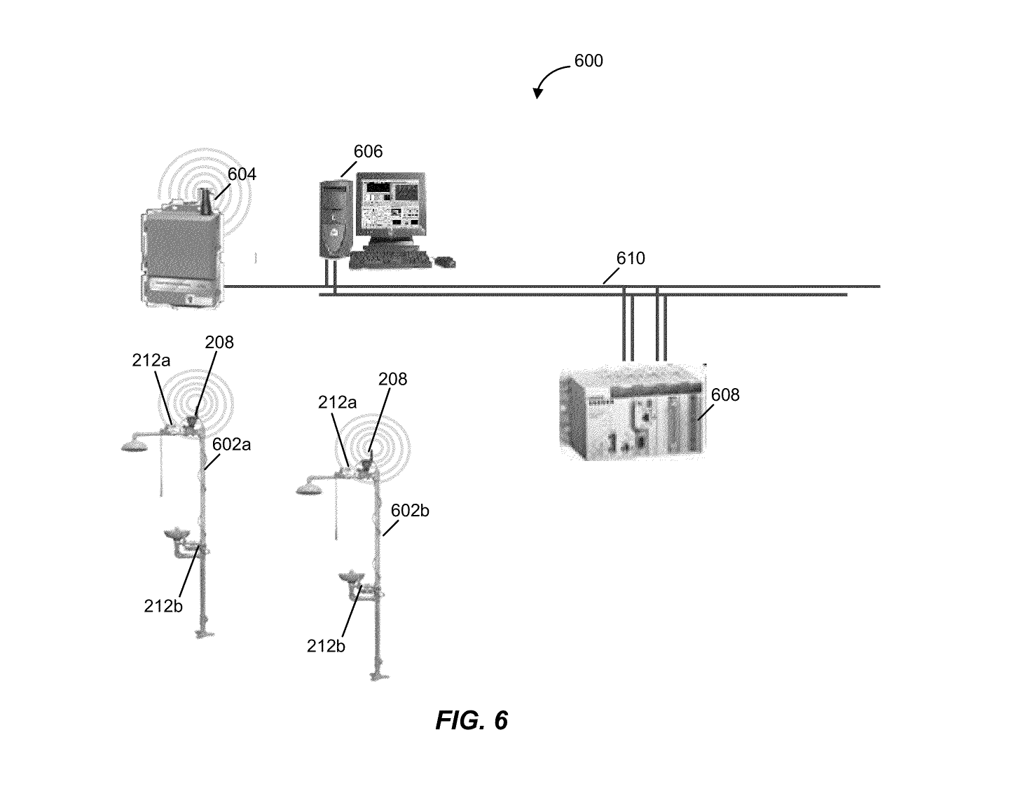

FIG. 6 illustrates another example system configuration within which wireless communication between safety stations and monitoring and control modules may be utilized, according to another embodiment;

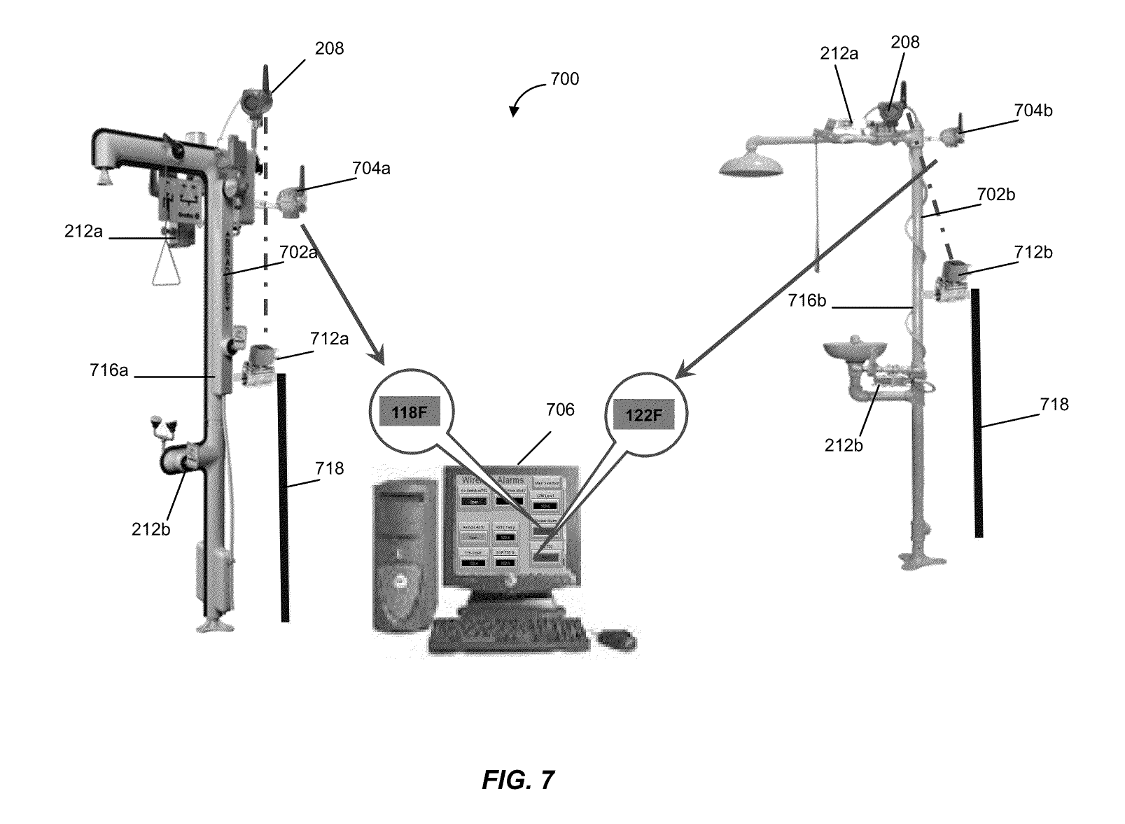

FIG. 7 illustrates an example embodiment in which each safety stations includes an additional wireless transmitter which may be used to transmit additional data, according to an embodiment.

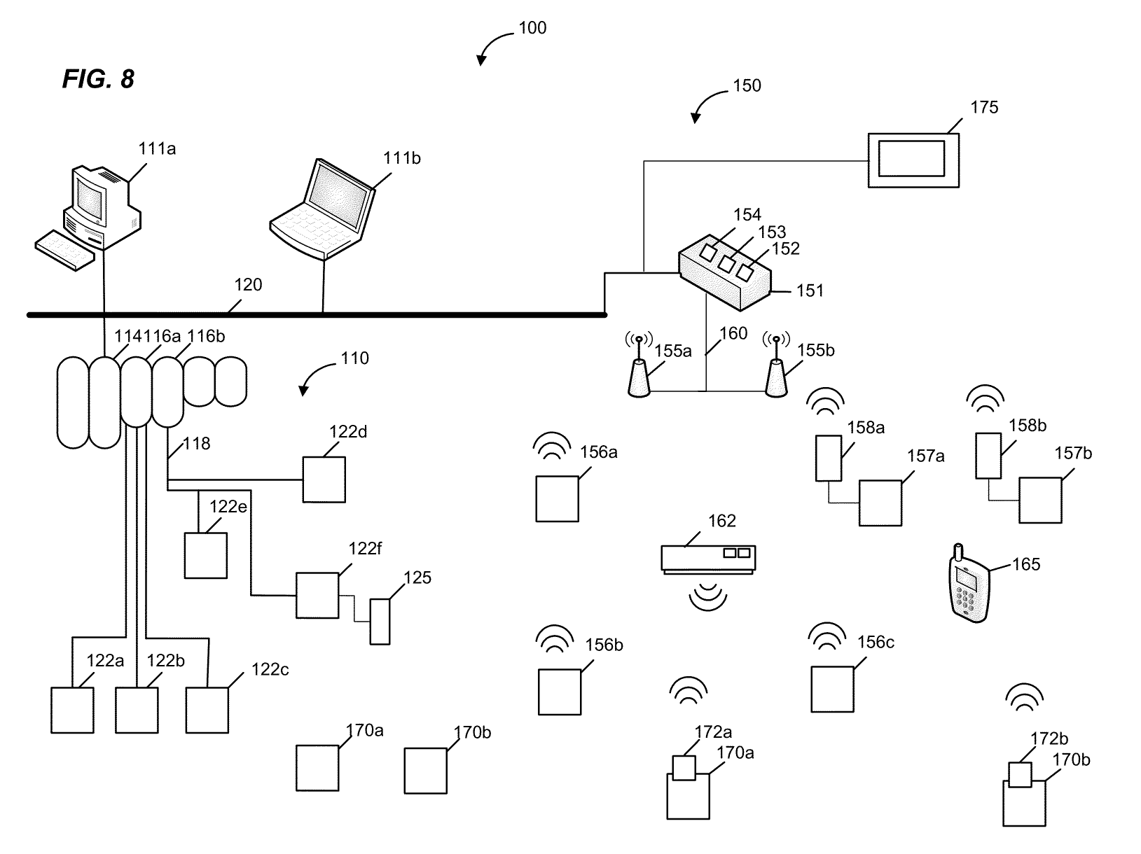

FIG. 8 illustrates an example process control system environment in which a wireless communication link to a safety station may be used, according to an embodiment.

### DETAILED DESCRIPTION

FIG. 1 illustrates an example process control system 10. The process control system 10 includes one or more process controllers 12 connected to one or more host workstations or computers 14 (which may be any type of personal computer or workstation) and connected to banks of input/output (I/O) devices 20, 22 each of which, in turn, is connected to one or more field devices 25. The controllers 12, which may be, by way of example only, DeltaV™ controllers sold by Fisher-Rosemount Systems, Inc., are communicatively connected to the host computers 14 via, for example, an Ethernet connection 40 or other communication link. Likewise, the controllers 12 are communicatively connected to the field devices 25 using any desired hardware and software associated with, for example, standard 4-20 ma devices and/or any smart communication protocol such as the Fieldbus or HART protocols. As is generally known, the controllers 12 implement or oversee process control routines stored therein or otherwise associated therewith and communicate with the devices 25 to control a process in any desired manner.

The field devices 25 may be any types of devices, such as sensors, valves, transmitters, positioners, etc. while the I/O cards within the banks 20 and 22 may be any types of I/O devices conforming to any desired communication or controller protocol such as HART, Fieldbus, Profibus, etc. In the embodiment illustrated in FIG. 1, the field devices 25a-25c are standard 4-20 ma devices that communicate over analog lines to the I/O card 22a. The field devices 25d-25f are illustrated as HART devices connected to a HART compatible I/O card 20A. Similarly, the field devices 25j-25l are smart devices, such as Fieldbus field devices, that communicate over digital bus 42 or 44 to the I/O cards 20B or 22B using, for example, Fieldbus protocol communications. Of course, the field devices 25 and the banks of I/O cards 20 and 22 could conform to any other desired standard(s) or protocols besides the 4-20 ma, HART or Fieldbus protocols, including any standards or protocols developed in the future.

Each of the controllers 12 is configured to implement a control strategy using what are commonly referred to as function blocks, wherein each function block is a part (e.g., a subroutine) of an overall control routine and operates in conjunction with other function blocks (via communications called links) to implement process control loops within the process control system 10. Function blocks typically perform one of an input function, such as that associated with a transmitter, a sensor or other process parameter measurement device, a control function, such as that associated with a control routine that performs PID, fuzzy logic, etc. control, or an output function that controls the operation of some device, such as a valve, to perform some physical function within the process control system 10. Of course hybrid and other types of function blocks exist. Groups of these function blocks are called modules. Function blocks and modules may be stored in and executed by the controller 12, which is typically the case when these function blocks are used for, or are associated with standard 4-20 ma devices and some types of smartfield devices, or may be stored in and implemented by the field devices themselves, which may be the case with Fieldbus devices. While the description of the control system is provided herein using function block control strategy, the control strategy could also be implemented or designed using other conventions, such as ladder logic, sequential flow charts, etc. and using any desired proprietary or non-proprietary programming language.

The process control system 10 further includes one or more safety stations 27 such as, for example, safety showers, eye wash stations, etc. The safety stations 27 may be monitored and/or controlled by a workstation 14, a remote wireless touch screen panel 70, a paperless recorder unit 72, or any other suitable monitoring and/or control devices, or a combination of such devices. The various control and/or monitoring devices may be located in a control room, a security office, a first responder station, etc. within a process plant. A safety stations 27 may be equipped with a wireless transmitter 31 to allow the safety station to wirelessly communicate with the monitoring or control devices. To this end, the process control system 10 also includes a base station (or a gateway) 60 that may receive signals from the wireless transmitter 31 using, for example, a HART protocol, an open process control (OPC) protocol, a modbus Ethernet protocol, a serial 485 protocol, etc. and relay these signals to the various control and/or monitoring devices via, for example, the Ethernet connection 40, or another suitable communication link.

In some embodiments, the process control system 10 includes a plurality of safety stations 27, all or some of which communicate wirelessly with various monitoring and/or control devices. In some such embodiments, a single base station 60 may be used to wirelessly connect multiple safety stations to the monitoring and/or control devices. In at least some embodiments, some of the safety stations 27 are connected to the monitoring and/or control devices via a wired connection, for example using the I/O devices 20, while some other safety stations are controlled and/or monitored via a wireless connection as described above.

FIG. 2 illustrates an example safety station 200 equipped for wireless communication with a host station, according to an embodiment. The safety station 200 may be incorporated within a process control system such as the example process control system 10 of FIG. 1 or the process control system 100 of FIG. 8. With reference to FIG. 1, one or both of the safety station 27b and 27c is the same as or similar to the safety station 200. Referring now to FIG. 8, one or both of the safety stations 170a and 170b is the same as or similar to the safety station 200. The safety station 200 includes a safety shower 202 and an eye wash station 204. The safety shower 202 may be activated by movement of a lever 214. Similarly, the eyewash station 204 may be activated by movement of a lever 216. A detector 212 is attached to the safety station 200 in the vicinity of the lever 214, and a detector 212b is attached to the safety station 200 in the vicinity of the lever 216. In an embodiment, each of the detectors 212a and 212b is a leverless limit switch that switches from a first state (e.g., normally open) to a second state (e.g., normally closed) in response to activation of the safety shower 202 and the eyewas station 204, respectively. For example, each of the detectors 212 may be a magnetic switch that switches from an “on” state to an “off” state, or vise versa, in response to sensing proximity to a magnetic target, such as a ferrous metal, for example, or another target. In this embodiment, the lever 214 and the lever 216 may each be a metallic lever, constructed from a ferrous metal, for example. In operation, the leverless limit switch 212a may be actuated (or latched) by a movement of the metallic lever 214 into a sensing range of the switch 212a, and the leverless limit switch 212b may be similarly activated (or latched) by a movement of the metallic lever 216 into a sensing range of the switch 212b. Once activated, each of the leverlelss limit switches 212 may stay latched until physically reset by an operator. Because leverless limit switches 212 operate by latching or unlatching in response sensing a magnetic target, in an embodiment, such switches may operate without a power supply, and, accordingly, no energy is needed to keep such switches in a position. In an example embodiment, the leveralss limit switches 212 are GO® switches manufactured by the TopWorx corporation. In general, GO® switches and other similar leverless limit switches provide superior performance in potentially harsh plant conditions (i.e., extreme temperatures, extreme pressure, exposure to corrosive substances, etc.).

In various embodiments, the leverless switches 212 are communicatively coupled to one or more wireless transmitters that transmit signals associated with the detectors 212 to a host station. In the embodiment illustrated in FIG. 2, a wireless transmitter 208 is a dual input transmitter which allows for a single transmitter to be used for transmitting signals detected by both of the detectors 212. In another embodiment, the transmitter 208 may be a single input device, and a separate transmitter may be coupled to each of the detectors 212. The transmitter 208 operates by transmitting a signal indicative of a state of a detector 212 connected to the transmitter 208 to a host station. Because the detectors 212, upon activation, remain latched until physically reset, the transmitter 208 continually transmits a signal indicating that the safety shower 202 and/or the eye wash station 204 has been activated until the corresponding switch 212 has been physically reset. Therefore, if a plant worker activates one or both of the switches 212 by turning on one or both of the shower 202 or the eye wash station 204, and then passes out or needs help (a “man down” scenario), the corresponding switch 212 will remain latched and an alarm signal will be continuously transmitted to a host station so that necessary assistance to the worker may be provided, according to an embodiment. In an example embodiment, the wireless transmitter illustrated 208 is the intrinsically safe Rosemount Wireless 702 Discrete Transmitter suitable for use in hazardous locations within a process plant. Of course, in other embodiments, the wireless transmitter 208 may be another suitable discrete wireless device capable transmitting signals indicative of a state of a limit switch connected to the wireless transmitter 208.

FIG. 3 illustrates an example arrangement 300 in which safety stations such as the safety stations 200 are monitored and/or controlled by a remote host, according to an embodiment. In the embodiment of FIG. 3, safety stations 302 are communicatively coupled to a wireless remote touch screen panel 308 via a base station device 304 and an Ethernet connection 310. In an embodiment, the safety stations 302 are the same as or similar to the safety station 200 of FIG. 2 and include like-numbered elements that are discussed above with respect to FIG. 2. In particular, each safety station 302 is equipped with a first leverless limit switch 212a to detect activation of a shower 202, a second leverless limit switch 212b to detect activation of an eye wash 204, and a transmitter 208 to transmit signals indicative of a state of each of the switches 212 to a monitoring module (in this case, the wireless panel 308) via a base station device 304. Referring to FIG. 1, the base station device 304 is the same as or similar to the gateway 60, according to an embodiment. Referring to FIG. 8, the base station device 304 is the same as or similar to the gateway 151, according to another embodiment.

In an embodiment, the wireless panel 308 may be located in the field, for example, in a first responder station, to allow an operator to monitor activity at various safety stations within the plant. In an embodiment, when a safety station is activated (e.g., a shower or an eye wash station is turned on), the wireless transmitter sends a corresponding signal (“alarm”) to notify an operator who may then follow a certain protocol to evaluate the situation and to act accordingly. In an embodiment, a switch 212 may latch upon detection of activation of a safety station 302, and remains latched until physically reset. As a result, in this embodiment, in a man down situation in which a worker may, for example, pass out or need help after activating a safety station 202, an alarm signal will be continuously transmitted to a first responder (or operator) monitoring the wireless panel 308, so that necessary assistance to the worker may be provided. In some embodiments, such alarm signals may additionally or alternatively be used by the operator at the wireless panel 308 to monitor usage of the safety station and identify safety station misuse (e.g., a safety shower used in a nonemergency situation, for example for washing hands or washing tools).

FIG. 4 illustrates an example arrangement 400 in which safety stations such as the safety stations 200 are monitored and/or controlled by a remote host, according to an embodiment. In the embodiment of FIG. 3, safety stations 402 are communicatively coupled to a wireless paperless recorder 408 via a base station device 404 and an Ethernet connection 412. In an embodiment, the safety stations 402 are the same as or similar to the safety station 200 of FIG. 2 and include like-numbered elements that are discussed above with respect to FIG. 2. In particular, each safety station 402 is equipped with a first leverless limit switch 212a to detect activation of a shower 202, a second leverless limit switch 212b to detect activation of an eye wash 204, and a transmitter 208 to transmit signals indicative of a state of each of the switches 212 to a monitoring module (in this case, the paperless recorder 408). Referring to FIG. 1, the base station device 404 is the same as or similar to the gateway 60, according to an embodiment. Referring to FIG. 8, the base station device 404 is the same as or similar to the gateway 151, according to another embodiment.

In an embodiment, the paperless recorder 408 may be used for keeping activation records of the safety stations 402. In this embodiment, the system arrangement 400 may be used, for example, to facilitate compliance with certain safety regulations (e.g., the American National Standards Institute (ANSI) guidelines or other standards used by the Occupational Safety and Health Administration (OSHA)) which may require safety stations within a processing plant to meet certain performance and maintenance criteria. Such guidelines may require that safety stations within a processing plant are activated for certain periods of time, for example, on a weekly basis. To facilitate compliance with such requirements, in an embodiment, the wireless transmitters 410 of the safety stations 402 may transmit a time stamp every time the safety stations 402 are activated (or deactivated) thereby generally simplifying maintenance and recording procedures associated with safety compliance. Of course, such time stamps may alternatively or additionally be used in a process plant monitoring and/or control system for a purpose other than safety regulation compliance.

FIG. 5 illustrates an example arrangement 500 in which safety stations such as the safety stations 200 of FIG. 2 are monitored and/or controlled by a remote host, according to an embodiment. In the example arrangement 500, safety stations 502 are communicatively coupled to an Ethernet switch 512 via a base station device 504 and an Ethernet connection 514. The Ethernet switch 512 may be connected to a remote wireless touch screen panel 508 and a programmable logic controller (PLC) 510. In an embodiment, the Ethernet switch 512 may receive signals, such as, for example alarm signals or other data associated with activation of the safety stations 502 and rout each received signal for display and/or analysis to one or both of the panel 504 and the PLC 510. In an embodiment, the safety stations 502 are the same as or similar to the safety station 200 of FIG. 2 and include like-numbered elements that are discussed above with respect to FIG. 2. In particular, each safety station 502 is equipped with a first leverless limit switch 212a to detect activation of a shower 202, a second leverless limit switch 212b to detect activation of an eye wash 204, and a transmitter 208 to transmit signals indicative of a state of each of the switches 212 to one or more control and/or monitoring modules (in this case, the wireless panel 508 and the PLC 510) via the base station device 504. Referring to FIG. 1, the base station device 504 is the same as or similar to the gateway 60, according to an embodiment. Referring to FIG. 8, the base station device 504 is the same as or similar to the gateway 151, according to another embodiment.

FIG. 6 illustrates an example arrangement 600 in which safety stations such as the safety stations 200 are monitored and/or controlled by a remote host, according to an embodiment. The example arrangement 600 includes two safety stations 602 communicatively coupled via a base station device 604 to a digital bus 610. In an embodiment, the Ethernet bus 610 may transport signals, such as, for example, alarm signals associated with activation of the safety stations 602 to a programmable logic controller (or a distributed control system (DCS)) 608, a workstation 606 (which may include a Human-Machine Interface (HMI) and/or other suitable devices, for analysis and/or display of alarms or other data associated with the safety stations to a human operator, a supervisory control and data acquisition (SCADA) module, etc.). In an embodiment, the safety stations 602 are the same as or similar to the safety station 200 of FIG. 2 and include like-numbered elements discussed above with respect to FIG. 2. In particular, each safety station 602 is equipped with a first leverless limit switch 212a to detect activation of a shower 202, a second leverless limit switch 212b to detect activation of an eye wash station 204, and a transmitter 208 to transmit signals indicative of a state of each of the switches 212 to one or more a control and/or monitoring modules (in this case, the host computer 606 and the DCS 608) via the base station device 604. Referring to FIG. 1, the base station device 604 is the same as or similar to the gateway 60, according to an embodiment. Referring to FIG. 8, the base station device 604 is the same as or similar to gateway 151, according to another embodiment.

FIG. 7 illustrates an example arrangement 700 in which safety stations such as the safety stations 200 are monitored and/or controlled by a remote host, according to an embodiment. The system configuration 700 includes two safety stations 702 communicatively coupled to a host computer 706. In an embodiment, each of the safety stations 702 is similar the safety station 200 of FIG. 2 and includes like-numbered elements as the safety station 200 of FIG. 2. In particular, each safety station 702 is equipped with a first leverless limit switch 212a to detect activation of a shower 202, a second leverless limit switch 212b to detect activation of an eye wash 204, and a transmitter 208 to transmit signals indicative of a state of each of the switches 212 to a host station.

A safety station 702 may also include a water temperature sensor 704 that may transmit temperature measurements to the host station 706. The host station 706 may display the temperature measurements received from each temperature sensor 704 to an operator. In addition, the host station 706 may transmit a control signal to the wireless transmitter 208, for example, which may also be also configured to receive the control signal from the host station 706 and to relay the control signal to a valve controller 712. The valve controller 712 may, in response to receiving the control signal from the wireless transmitter 208, cause flushing of a pipe 716 that supplies water to a safety station 702. The valve controller 712 may cause flushing of the pipe 716 by directing static water in the pipe 716 to a flush pipe 718, for example. The host station may control the valve controller to cause flushing of a pipe 716 if static water in the pipe 716 has become too hot or too cold, for example, as indicated by a temperature measurement by a corresponding temperature sensor 702.

Although each of the arrangements 300-700 discussed above with respect to FIGS. 3-7 is illustrated as having only two safety stations, each of the arrangements 300-700 may include other suitable numbers of safety stations communicatively coupled to one or more base station devices in other embodiments. As an example, in an embodiment, a single base station device (e.g., base station device 304 of FIG. 3, base station 304 device of FIG. 4, etc.) may support up one hundred safety stations.

FIG. 8 illustrates another example process control system 100 incorporating wirelessly monitored and/or controlled safety stations in accordance with the present disclosure, according to another embodiment. The example process system 100 is generally similar to the process system 10 of FIG. 1, but includes several modules and elements not shown in FIG. 1. The example process control system 100 includes a wired plant automation network 110 that operates according to an industrial automation protocol (e.g., HART, PROFIBUS DP (Decentralized Peripherals), etc.) or another suitable communication protocol, and a wireless plant automation network 150 that operates according to a suitable wireless communication protocol (e.g., WirelessHART, ISA100.11a, a Wi-Fi protocol, a wireless personal area network (WPAN) protocol, a proprietary wireless protocol, etc.), or another suitable wireless communication protocol. The wired plant automation network 110 includes one or more controllers 114 connected to one or more host workstations or computers 111 (which may be any type of personal computer or workstation) and connected to banks of input/output (I/O) devices 116 each of which, in turn, is connected to one or more field devices 122. The controllers 114, which may be, by way of example only, DeltaV™ controllers sold by Fisher-Rosemount Systems, Inc., are communicatively coupled to the host computers 111 via, for example, an Ethernet connection 120 or other communication link. Likewise, the controllers 114 are communicatively coupled to the field devices 122 using any suitable hardware and software associated with, for example, standard 4-20 ma devices and/or any smart communication protocol such as the Fieldbus or HART protocols. As is generally known, the controllers 114 implement or oversee process control routines stored therein or otherwise associated therewith and communicate with the devices 122 to control a process in any desired manner.

The field devices 122 may be any types of devices, such valves, valve positioners, switches, sensors (e.g., temperature, pressure, vibration, flow rate, or pH sensors), pumps, fans, etc., or combinations of two or more of such types, while the I/O cards within the card bank 116 may be any types of I/O devices conforming to any suitable communication or controller protocol such as HART, Fieldbus, Profibus, etc. Field devices 122 perform control, monitoring, and/or physical functions within a process or process control loop, such as opening or closing valves or taking measurements of process parameters, for example. In the embodiment illustrated in FIG. 8, the field devices 122a-122c are standard 4-20 ma devices that communicate over analog lines to the I/O card 116a. In another embodiment, the field devices 112a-122c are Hart devices and the I/O card 116a is a Hart compatible I/O card. In one embodiment, the control system 100 includes 4-20 ma devices as well as Hart devices. Accordingly, in this embodiment, the control system 100 includes one or more 4-20 ma compatible I/O cards as well as one or more Hart compatible I/O cards.

In the embodiment of FIG. 8, the field devices 122d-122f are smart devices, such as Fieldbus field devices, that communicate over the digital bus 118 to the I/O card 118 using, for example, Fieldbus protocol communications. Of course, the field devices 122 and the banks of I/O cards 116 could conform to any other suitable standard(s) or protocols besides the 4-20 ma, HART or Fieldbus protocols, including any standards or protocols developed in the future.

Similar to the controllers 12 of FIG. 1, each of the controllers 114 is configured to implement a control strategy using what are commonly referred to as function blocks, wherein each function block is a part (e.g., a subroutine) of an overall control routine and operates in conjunction with other function blocks (via communications called links) to implement process control loops within the process control system 100. Function blocks typically perform one of an input function, such as that associated with a transmitter, a sensor or other process parameter measurement device, a control function, such as that associated with a control routine that performs PID, fuzzy logic, etc. control, or an output function that controls the operation of some device, such as a valve, to perform some physical function within the process control system 100. Of course hybrid and other types of function blocks exist. Groups of these function blocks are called modules. Function blocks and modules may be stored in and executed by the controller 114, which is typically the case when these function blocks are used for, or are associated with standard 4-20 ma devices and some types of smartfield devices, or may be stored in and implemented by the field devices themselves, which may be the case with Fieldbus devices. While the description of the control system is provided herein using function block control strategy, the control strategy could also be implemented or designed using other conventions, such as ladder logic, sequential flow charts, etc. and using any suitable proprietary or non-proprietary programming language.

As discussed above, the process control system 100 also includes the wireless communication network 150 that utilizes or operates according to a suitable wireless communication protocol. For clarity, the discussion herein refers to the WirelessHART communication protocol, although the techniques and principles described herein may apply to wireless plant automation networks that utilize other wireless industrial automation protocols in addition to or instead of WirelessHART, or to networks that utilize only wired communications.

The wireless communication network 150 includes a gateway 151 connected to the communication backbone 120 in a wired manner and may communicate with the host stations 111 using a suitable protocol. The gateway 151 may be implemented as a stand-alone device, as a card that can be inserted into an expansion slot of one of the host workstations 111, as part of an input/output (I/O) subsystem of a programmable logic controller (PLC) system or distributed control system (DCS), or in any other manner. The gateway 151 may provide host stations 111, and applications executed thereon, access to various devices of the wireless plant automation network 150 . In addition to protocol and command conversion, the gateway 151 may provide synchronized clocking that is used by time slots and superframes (i.e., sets of communication time slots that are spaced equally in time) of the scheduling scheme of the wireless plant automation network 150.

In some embodiments, the gateway 151 is functionally divided into a virtual gateway 152 and one or more network access points 155. In the process control system 100 shown in FIG. 1, the network access points 155 are separate physical devices in wired communication with the gateway 151. Alternatively, the elements 151, 152, 155 and 158 may instead be parts of an integral device, and/or the connections 158 may be wireless connections. Physically separate network access points 155 may be strategically placed in several distinct locations, thereby increasing the overall reliability of the communication network 100 by compensating for poor signal quality at the location of one or more of the network access points 155. Having multiple network access points 155 also provides redundancy in case of failure of one or more of the network access points 155.

The gateway device 151 may additionally contain a network manager software module 153 and a security manager software module 154. In another embodiment, the network manager software module 153 and/or the security manager software module 154 may run on a host workstation 111. For example, the network manager software module 153 may run on the stationary host workstation 111a and the security manager software module 154 may run on the portable host workstation 111b. The network manager software module 153 may be responsible for tasks such as configuration of the communication network 100, scheduling of communications between multiple WirelessHART devices (e.g., configuring superframes), management of routing tables, and monitoring and reporting of the health of the wireless plant automation network 150, for example. While redundant network manager software modules 153 may be supported, an example embodiment includes only one active network manager software module 153 per wireless plant automation network 150. The security manager software module 154 may be responsible for managing and distributing security encryption keys, and may maintain a list of devices that are authorized to join the wireless plant automation network 150 and/or the wired plant automation network 110, for example.

The wireless plant automation network 150 also includes one or more field devices 156, 157, each of which is in some manner equipped for wireless communication with other devices 156, 157, a host station, a portable device, etc. Each of the field devices 156, 157 may be, for example, a valve, a valve positioner, a switch, a sensor (e.g., temperature, pressure, vibration, flow rate, or pH sensor), a pump, a fan, etc., or a combination of two or more such devices. Field devices 156, 157 perform control, monitoring, and/or physical functions within a process or process control loop, such as opening or closing valves or taking measurements of process parameters, for example. In the example wireless plant automation network 150, the field devices 156, 157 are also producers and consumers of wireless communication packets, such as WirelessHART packets. Some or all of the field devices 156, 157 may additionally serve as routers for messages from and to other devices.

The field devices 156 may be WirelessHART devices, meaning that each of field devices 156 is provided as an integral unit supporting all layers of the WirelessHART protocol stack. For example, the field device 156a may be a WirelessHART flow meter, the field devices 156b may be WirelessHART pressure sensors, the field device 156c may be a WirelessHART valve positioner, and the field device 156d may be a WirelessHART vibration sensor. The field device 157a may be a legacy 4-20 mA device, and the field device 157b may be a wired HART device. In the example process control system 100 shown in FIG. 1, each of field devices 157 is connected to the wireless plant automation network 150 via a WirelessHART adaptor (WHA) 158. Each WHA 158 may also support other communication protocols such as FOUNDATION Fieldbus, PROFIBUS, DeviceNet, etc., in which case the WHA 158 supports protocol translation on a lower layer of the protocol stack. A single WHA 158 may additionally function as a multiplexer and support multiple HART or non-HART devices.

Referring still to FIG. 1, the wireless plant automation network 150 of the example process control system 100 also includes a router device 162. The router device 162 is a network device that forwards packets from one network device to another. A network device that is acting as a router uses internal routing tables to determine another network device to which the routing network device should forward a particular packet. Stand-alone routers such as the router 162 may not be required where other devices on the wireless plant automation network 150 support routing. However, it may be beneficial to add the dedicated router 162 to the wireless plant automation network 150 in order to extend the network, for example, or to save the power of field devices in the network.

The wireless plant automation network 150 further includes one or more safety stations 170 such as, for example, safety showers, eye wash stations, etc. The safety stations 170 may be monitored and/or controlled by a workstation 111, a remote wireless panel 175, or any other suitable monitoring and/or control devices, or a combination of such devices. The various control and/or monitoring devices may be located in a control room, a security office, a first responder station, etc. within a process plant. A safety stations 170 may be equipped with a wireless transmitter 172 to allow the safety station to wirelessly connect to the network 150 for communicating with the monitoring and/or control devices. Although only two safety stations 170 are illustrated in FIG. 8 for clarity, the network 150 includes a considerably greater number of safety stations 170 in some embodiments. In some embodiments, the wireless network 150 also includes additional gateways 151 to support larger numbers of safety stations. In an embodiment, a single wireless gateway 151 is capable of supporting up to 100 safety stations, for example.

Although FIG. 8 depicts the communication network 100 as including both a wired plant automation network 110 and a wireless plant automation network 150, the communication network 100 may instead include only the wired plant automation network 110 or only the wireless plant automation network 150. In one embodiment, the wireless plant automation network 150 is a wireless mesh communication network.

All devices directly connected to the wireless plant automation network 150 may be referred to as network devices of the wireless plant automation network 150. In particular, the WirelessHART field devices 156, 157, the WHAs 158, the routers 162, the gateway 151, the network access points 155, the handheld device 165 may, and the safety stations 170 for the purposes of routing and scheduling, be referred to as the network devices of the wireless plant automation network 150. In order to provide a very robust and an easily expandable network, all network devices may support routing and each network device may be globally identified by its HART address. Moreover, the network manager software module 153 may contain a complete list of network devices and assign each device a network-unique name (e.g., a 16-bit name). Further, each network device may store information related to update rates, connection sessions, and device resources. In short, each network device may maintain up-to-date information related to routing and scheduling. In some embodiments, the network manager software module 153 communicates this information to network devices whenever new devices (e.g., new field devices) join the network or whenever the network manager detects or originates a change in topology or scheduling of the wireless plant automation network 150.

In addition to generating, receiving, and/or forwarding data relating to the primary operations of the process control system 100 (e.g., temperature sensor data, data for controlling valve positions, etc.), the devices of the process control system 100 may communicate data relating to maintenance of devices in the process control system 150. For example, a field device may send data to a host when the field device is operating improperly (e.g., when a spool valve of a valve positioner is inoperable), or is at risk of improper operation (e.g., when a voltage of a power module of the device falls below a certain level). As another example, a field device may continuously or periodically send to a host certain data relating to proper operation (e.g., data indicating that certain action or actions have been successfully performed by a field device). The host receiving such data (e.g., the host workstation 111) may display indicators based on that data via a graphical user interface (GUI), thereby allowing a human operator to take the appropriate corrective or preventive measures, or may utilize such data in keeping historical records of equipment and/or processes operation within the process control system 100.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention. It is intended that the specification and examples be considered as exemplary only, with a true scope and spirit of the invention being indicated by the following claims.

1. A safety station for use in a process plant, the safety station comprising:
one or more leverless limit switches to detect activation of one or more parts of the safety station; and
a wireless transmitter coupled to the leverless limit switches to transmit signals associated with the safety station to a base station device, wherein the base station device is communicatively coupled to one or more control and/or monitoring modules.

2. The safety station of claim 1, wherein the leverless limit switch is a GO® switch manufactured by the TopWorx corporation.

3. The safety station of claim 1, wherein the leverless limit switch remains latched until physically reset.

4. The safety station of claim 1, wherein the wireless transmitter is the Rosemount 702 dual input transmitter manufactured by the Emerson corporation.

5. The safety station of claim 1, wherein the wireless transmitter is an intrinsically safe wireless transmitter.

6. The safety station of claim 1, wherein the safety station is a safety shower and/or an eye wash station.

7. The safety station of claim 1, wherein at least one of the one or more control and/or monitoring stations is a remote touch screen panel.

8. The safety station of claim 1, wherein at least one of the one or more control and/or monitoring stations is a paperless recorder.

9. The safety station of claim 1, wherein at least one of the one or more control and/or monitoring stations is a workstation.

10. A safety station monitoring and control system in a process plant, the system comprising:
one or more safety stations equipped with a leverless limit switch and a wireless transmitter coupled to the leverless switch, and a base station communicatively coupled a first monitoring and/or control module.

11. The system of claim 10, wherein the leverless limit switch is a GO® switch manufactured by the TopWorx corporation.

12. The system of claim 10, wherein the leverless limit switch remains latched until physically reset.

13. The system of claim 10, wherein the wireless transmitter is the Rosemount 702 dual input transmitter manufactured by the Emerson corporation.

14. The system of claim 10, wherein the wireless transmitter is an intrinsically safe wireless transmitter.

15. The system of claim 10, wherein the one or more safety station comprise a safety shower and an eye wash station.

16. The system of claim 10, wherein at least one of the one or more control and/or monitoring stations is a remote touch screen panel.

17. The system of claim 10, wherein at least one of the one or more control and/or monitoring stations is a paperless recorder.

18. The system of claim 10, wherein at least one of the one or more control and/or monitoring stations is a workstation.

19. The system of claim 10, wherein the base station is further coupled to a second monitoring and/or control module.

20. The system of claim 10, wherein the monitoring and/or control module is configured to detect safety station misuse.

21. The system of claim 10, wherein the monitoring and/or control module is configured to detect a man down situation.

22. The system of claim 10, wherein at least one of the monitoring and/or control modules is configured to record safety station activation events for a safety standard compliance.
